(19) United States
(12) Patent Application Publication
(10) Pub. No.: US 2021/0237317 A1
(43) Pub. Date: Aug. 5, 2021

(54) METHOD FOR RECYCLING COMPOSITE MATERIALS WITH AN IMPROVED ENERGY BALANCE

(71) Applicant: Arkema France, Colombes (FR)

(72) Inventor: Jean-Luc DUBOIS, Millery (FR)

(21) Appl. No.: 17/049,700

(22) PCT Filed: Apr. 26, 2019
(86) PCT No.: PCT/FR2019/050985

§ 371 Date: Oct. 22, 2020

(30) Foreign Application Priority Data
Apr. 27, 2018 (FR) 18.53711

(51) Int. Cl. B29B 17/02; B29B 17/04; B02C 19/18; B02C 23/10

(52) U.S. Cl. CPC B29B 17/0206; B29B 17/04; B02C 19/186; B29B 2017/0224; B29B 2017/0231; B29B 2017/0496; B29B 2017/0255; B02C 23/10

(57) ABSTRACT

The invention relates to a process for recycling articles comprising a composite material, the composite material comprising a polymer matrix and a reinforcement, said process being characterized in that it comprises the following steps:
introducing the article into a reactor suitable for heating the article,
heating the article in the reactor at a given temperature, in order to destructure the polymer matrix,
separating the reinforcement from the destructured polymer matrix, and
contacting the reinforcement with a first heat-transfer means in order to recover heat.
   The invention also relates to a system for recycling an article made of composite material.

### TECHNICAL FIELD

The present invention relates generally to the recycling of articles made of composite material, more particularly to a composite material recycling process with an improved energy balance.

The invention is useful in all industrial sectors confronted with the problems of recycling of post-consumer composite waste such as end-of-life products, or industrial waste such as defective products or scraps originating from plastic processing operations.

### PRIOR ART

A composite material (also abbreviated to “composite”) is a macroscopic combination of at least two materials which are immiscible with one another. Generally, the composite material is composed of a polymer matrix which forms a continuous phase on the one hand, and of a reinforcing material (or reinforcement) which is generally a fibrous reinforcement on the other hand. There are also composites consisting of a polymer matrix and mineral filler, for example quartz, marble, silica, aluminum hydroxide, TiO₂, etc. Optionally, the composite material also comprises additives. These materials are furthermore often combined with other components such as metal inserts, wood or foams in order to manufacture articles intended for various industries.

The recycling of articles comprising a composite based on a polymer matrix or polymer composite can be carried out according to several methods. These methods generally involve the thermal degradation of the polymer, i.e. the action of heat or a rise in temperature of the polymer causes the loss of the mechanical and physical properties of the polymer.

Pyrolysis is known, which is a thermal process consisting in placing the article to be treated in a suitable chamber and then heating the chamber so that the heat is transferred to the article. The pyrolysis temperature is generally between 400° C. and 1300° C. in order to enable the chemical decomposition of the polymer matrix. Pyrolysis of the article leads to the formation of gas, an oily residue and a solid residue comprising the reinforcement of the composite, inorganic fillers and a carbonaceous solid. The gases obtained after pyrolysis can be reused in the manufacture of new polymer articles, and the solid residue obtained after pyrolysis is in particular reused in the manufacture of other products such as insulation materials. This recycling method has a poor energy balance.

Fluidized bed processes are also known in which the fluidized bed can be a bed of silica sand, for example. In this process, the article comprising a composite is generally preground and is placed in a fluidized bed reactor containing the fluidized bed. Fluidization is carried out using a gas stream heated at a temperature generally above 400° C. In this bed, the matrix is rapidly heated and gasified, thus removing the reinforcement from the matrix. A portion of the reinforcement is then carried out of the bed in the gas stream to a secondary combustion chamber. Another portion is entrained with the solid constituting the fluidized bed, and taken into a vessel where the solid is reheated, and the carbonaceous residues burnt before being returned to the fluidized bed reactor. As with pyrolysis, this method is not designed so as to optimize the energy balance thereof. In both cases, at the end of the depolymerization/gasification, the solid constituting the reinforcement is discharged, and the heat which it has accumulated is lost. The heat lost is greater, the greater the mass of non-depolymerizable/non-gasifiable material.

Chemical treatment of a composite article by solvolysis is also a known recycling method. It consists in treating the composite material of the article with a solvent suitable for enabling the depolymerization of the polymer matrix. It may be carried out at temperatures below 200° C., or under supercritical conditions with temperatures above 200° C. and at high pressures (above 200 bar). Solvolysis can be seen as a “disassembling” of the composite material resulting on the one hand in an inorganic fraction comprising in particular the reinforcement of the composite material, and on the other hand in a liquid solution comprising the products resulting from the depolymerization and the solvent. At the end of the solvolysis process, the reinforcement and the polymer solution can be reused.

It appears that the known methods of recycling articles comprising a composite material involve various heating steps which may, for example, consist in heating a solvent with a view to solvolysis, or, in heating a gas to fluidize a bed of sand, or in heating a reactor to induce pyrolysis. These various heating steps require the input of energy in the form of heat, and an undesirable consequence is the consumption of a significant portion of the energy to heat fibrous reinforcements and mineral fillers (or any other non-depolymerizable/non-gasifiable material) contained in the composites. Specifically, the composite materials may comprise up to 70% by weight, or even more, of non-depolymerizable solid compounds constituting the fibrous reinforcement, such as glass fibers for example. The amount of energy devoted to heating these non-depolymerizable solid compounds must therefore be seen as a loss in the energy balance of the operation.

Consequently, from an energy and environmental point of view, it is desirable to be able to have a recycling method that enables an improvement in the energy balance.

Document EP2752445A1 describes a process and a device for recycling composite material comprising a polymer matrix and a carbon fiber reinforcement. The objective of that document is not to deteriorate the carbon fibers during the recycling of the composite material in order to be able to recycle them to processes for manufacturing nonwovens. The composite article to be recycled is introduced into a reactor in which it is heated in order to destructure the polymer matrix.

Document JP3899563 describes the recycling of a composite material with a polymer matrix and a fibrous reinforcement made of glass fibers.

For this, the material to be recycled is introduced into a reactor and heated at a temperature below the melting point of the glass fibers until the combustion of organic matter progresses and the amount of residual carbon decreases.

Document WO 2017/178681 describes a process for recycling composite material comprising a fibrous reinforcement made of carbon fibers and/or of glass fibers. The composite material is introduced into a horizontal reactor which comprises 3 independent zones separated from one another by separation gates.

Document DE102007026748 describes a process and an apparatus for the continuous recycling of composite material reinforced with carbon fibers. For this, the material is conveyed into a tunnel reactor comprising a preheating chamber, a pyrolysis chamber and a reheating chamber.

### Technical Problem

The aim of the invention is thus to overcome at least one of the abovementioned drawbacks of the prior art.

The invention aims in particular to provide a simple and effective solution for depolymerizing a constituent polymer of a composite material article, making it possible to improve the energy balance and in particular to recover the amount of heat absorbed by the solid, non-depolymerizable, fibrous material.

### BRIEF DESCRIPTION OF THE INVENTION

For this purpose, a first aspect of the invention proposes a process for recycling an article comprising a composite material, said composite material comprising a polymer matrix and a reinforcement, said process being characterized in that it comprises the following steps:
introducing the article into a reactor suitable for heating the article,
heating the article in the reactor at a given temperature, in order to destructure the polymer matrix,
separating the reinforcement from the destructured polymer matrix, and
contacting the reinforcement with a first heat-transfer means in order to recover heat.

Thus, it is possible to transfer the sensible heat accumulated in the reinforcement, with a view to reusing this heat. This heat must additionally be able to be recovered at one or more thermal levels in order to be able to reuse it in downstream operations for purifying the monomer obtained or upstream operations for drying materials. Thus, the process makes it possible to carry out a recycling of articles comprising a composite material, the carbon footprint of which is reduced. The method according to the invention is therefore more environmentally friendly.

Moreover, the process according to the invention is particular advantageous for composites containing more than 40% by weight of reinforcement and preferably for composites containing more than 50% by weight of reinforcement and more preferably for composites containing more than 60% by weight of reinforcement and advantageously for composites containing more than 70% by weight of reinforcement.

According to Other Optional Features of the Process:
the article is introduced into the reactor by means of an endless screw, a conveyor belt, a hopper or a metering module;
the article is heated at a temperature between 200° C. and 1500° C.;
the reinforcement is separated by at least one of the following processes: centrifugation, draining, spinning, pressing, filtering, screening and/or cycloning;
the first heat-transfer means is a heat exchanger with direct contact between the reinforcement and a heat-transfer fluid;
the first heat-transfer means is a device for immersion in the heat-transfer fluid or for spraying the heat-transfer fluid;
the first heat-transfer means is a heat exchanger with indirect contact between the reinforcement and a heat-transfer fluid;
a protection agent is added to the reinforcement;
the recovered heat is used in the article recycling process in addition to heat input by an external heat source;
the recovered heat is used to preheat the article before the introduction thereof into the reactor;
the process further comprises a step consisting in bringing the reinforcement into contact with a second heat-transfer means in order to recover additional heat, after the heat recovery by contacting the reinforcement with the first heat-transfer means;
the polymer matrix comprises polymethyl methacrylate (PMMA);
a portion of the destructured matrix is reintroduced into the reactor after separation from the reinforcement. This may enable, on the one hand, a faster destructuring of the matrix of the next articles and make it possible, on the other hand, to improve the recycling of the reintroduced matrix.

The invention also relates to a system for recycling an article comprising a composite material comprising a polymer matrix and a reinforcement, said system being characterized in that it comprises:
a means for conveying said article,
a reactor suitable for heating said article with a view to destructuring the polymer matrix thereof,
a means for separating the reinforcement from the destructured polymer matrix, and
a first heat-transfer means suitable for recovering heat from the reinforcement.

The recycling system according to the invention may further comprise a second heat-transfer means capable of recovering additional heat from the reinforcement.

Other features and advantages of the invention will become apparent on reading the following description, given by way of illustration and without implied limitation with reference to the appended figures which depict:

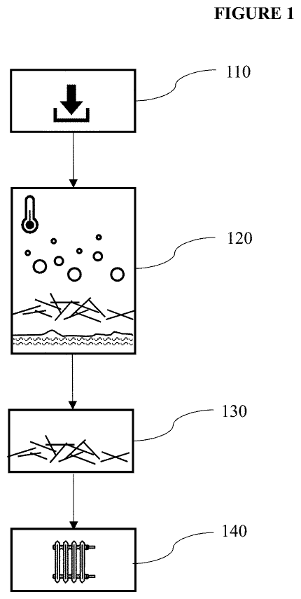

FIG. 1, a step diagram of the recycling process according to one embodiment,

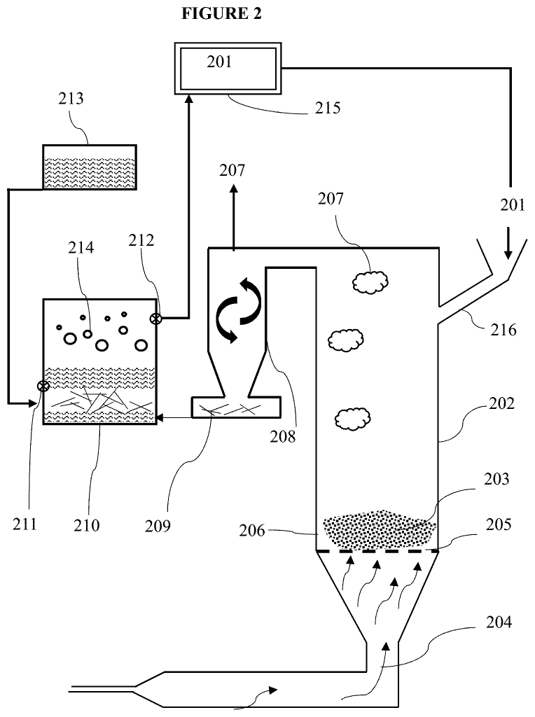

FIG. 2, a diagram showing an example of heat transfer by a direct contact heat exchanger,

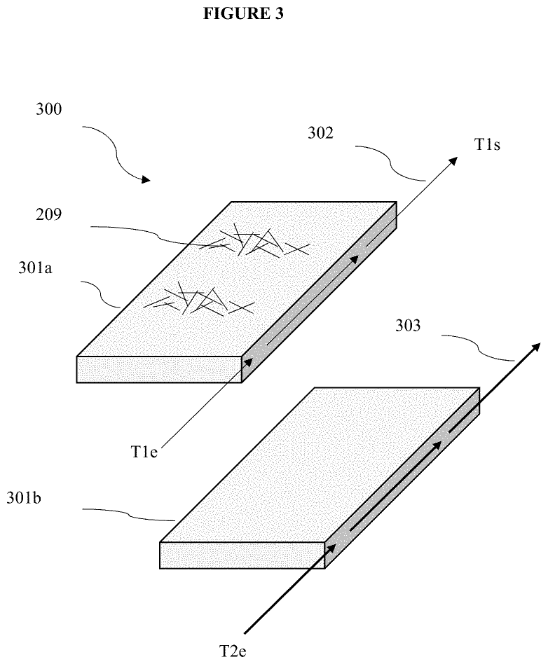

FIG. 3, a diagram of a plate heat exchanger, and

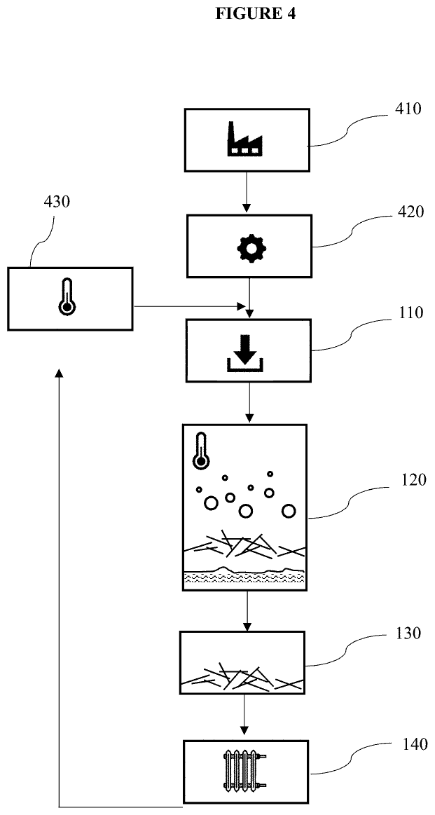

FIG. 4, a step diagram of the recycling process according to another embodiment.

### DESCRIPTION OF THE INVENTION

In the remainder of the description, the term “monomer” is understood to mean a molecule which can undergo polymerization.

The term “polymerization” as used relates to the process for converting a monomer or a mixture of monomers into a polymer.

The term “polymer” is understood to mean either a copolymer or a homopolymer. A “copolymer” is a polymer grouping together several different monomer units and a “homopolymer” is a polymer grouping together identical monomer units.

The term “depolymerization” as used relates to the process for converting a polymer into one or more monomer(s) and/or oligomer(s) and/or polymer(s) of reduced molecular weight relative to the molecular weight of the initial polymer.

A “polymer of reduced weight” is understood to mean a polymer whose weight-average molecular weight is lower than the weight-average molecular weight of the initial polymer constituting the matrix. The weight-average molecular weight may be measured by size exclusion chromatography.

A “thermoplastic polymer” or “thermoplastic” is understood to mean a polymer which, in a repeated manner, can be softened or melted under the action of heat and which takes on a new shape by application of heat and pressure. Examples of thermoplastics are, for example: high-density polyethylene (HDPE) used in particular for the production of plastic bags or for motor vehicle construction; polyethylene terephthalate (PET) or else polyvinyl chloride (PVC) which are used in particular for the production of plastic bottles; polymethyl methacrylate (PMMA). Thus, the use of thermoplastics affects a wide variety of sectors, ranging from packaging to the motor vehicle industry, and the demand for plastics remains high.

A “thermosetting polymer” is understood to mean a plastic material which is irreversibly converted by polymerization into an insoluble polymer network.

A “(meth)acrylic polymer” is understood to mean a homopolymer or a copolymer based on (meth)acrylic monomer, which is for example chosen from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate and mixtures thereof. Poly(methyl methacrylate) (PMMA) is a particular example of a (methacrylic) polymer obtained by polymerization of a methyl methacrylate monomer.

For the purposes of the invention, the term “PMMA” denotes homopolymers and copolymers of methyl methacrylate (MMA), the weight ratio of MMA in the PMMA preferably being at least 70% by weight for the MMA copolymer. The term “copolymer based on methyl methacrylate” means a copolymer containing at least one methyl methacrylate monomer. For example, a copolymer based on methyl methacrylate may be a copolymer comprising at least 70%, preferably 80%, advantageously 90% by weight of MMA in the PMMA.

The term “base monomer” means the most predominant monomer unit constituting a polymer. Thus, in PMMA, the base monomer is MMA.

A “polymer matrix” is understood to mean a solid material serving as a binder. The “matrix” includes polymers and/or oligomers. Thus, a “(meth)acrylic polymer matrix” relates to any type of acrylic and methacrylic compounds, polymers, oligomers or copolymers. However, it would not constitute a departure from the scope of the invention if the (meth)acrylic polymer matrix comprised up to 10% by weight, preferably less than 5% by weight, of other nonacrylic monomers chosen, for example, from the following group: butadiene, isoprene, styrene, substituted styrene, such as α-methylstyrene or tert-butylstyrene, cyclosiloxanes, vinylnaphthalenes and vinylpyridines.

For the purposes of the invention, a “composite” is understood to mean a multi-component material comprising at least two immiscible components, in which at least one component is a polymer and the other component may be, for example, a fibrous reinforcement.

A “reinforcement” is understood to mean a non-depolymerizable or non-gasifiable solid material such as a “fibrous reinforcement” or a “mineral filler” which remains at the end of the treatment.

A “fibrous reinforcement” is understood to mean an assembly of fibers, unidirectional rovings or a continuous filament mat, woven fabrics, felts or nonwovens which may be in the form of strips, webs, braids, rovings or parts.

The term “mineral fillers” is understood to mean all pulverulent fillers, for example quartz, marble, silica, aluminum hydroxide or TiO₂.

The term “destructuring” is understood to mean a process according to which the polymer of the matrix of a composite material is treated to result in a mixture in the molten state and/or a gaseous mixture, thus making it possible to free the fibrous reinforcement. Destructuring may result in depolymerization which is a process in which the polymer of the matrix is fragmented to result in a mixture in the molten state and/or a mixture in gas form. The fragmentation of the polymer may in particular lead to the base monomer of the polymer.

A “heat exchanger” is understood to mean a system for transferring heat between a first component and a second component, the first component having a higher temperature than the second component.

A “direct-contact heat exchanger” is understood to mean an exchanger without a dividing wall between the first and the second component.

An “indirect-contact heat exchanger” is understood to mean an exchanger in which the first component is not in contact with the second component, for example in which the hot reinforcement is not in intimate contact with the fluid.

For the purposes of the invention, the term “substantially equal” is understood to mean a value varying by less than 30% relative to the compared value, preferably by less than 20%, more preferably still by less than 10%.

In the following description of the embodiments and in the appended figures, the same references are used to denote the same components or similar components.

The invention also relates to a process for recycling an article made of composite material. The composite material of the article to be recycled comprises at least one polymer matrix and a reinforcement.

The polymer matrix can be a thermosetting polymer matrix or a thermoplastic polymer matrix.

Thermosetting or thermoset polymers are polymers having a crosslinked three-dimensional structure. Thermoset polymers are shaped when hot and are crosslinked into the desired shape. Once the shape of the thermosetting polymer is fixed and cooled, it can no longer be modified under the action of heat. Thermosetting polymers are for example: unsaturated polyesters, polyimides, polyurethanes or vinyl esters which may be epoxy or phenolic.

Matrices based on thermoplastic polymer are generally preferred because they are thermoformable and more easily recyclable. As non-limiting examples, the thermoplastic polymer matrix may be based on a homopolymer and copolymer of olefins such as acrylonitrile-butadiene-styrene copolymers, styrene-butadiene-alkyl methacrylate (or SBM) copolymers; polyethylene, polypropylene, polybutadiene and polybutylene; acrylic homopolymers and copolymers and polyalkyl methacrylates such as poly(methyl methacrylate); homopolyamides and copolyamides; polycarbonates; polyesters including poly(ethylene terephthalate) and poly(butylene terephthalate); polyethers such as poly(phenylene ether), poly(oxymethylene), poly(oxyethylene) or poly(ethylene glycol) and poly(oxypropylene); polystyrene; copolymers of styrene and maleic anhydride; poly(vinyl chloride); fluoropolymers such as poly(vinylidene fluoride), polyethylene tetrafluoride and polychlorotrifluoroethylene; natural or synthetic rubbers; thermoplastic polyurethanes; polyaryl ether ketones (PAEK) such as polyetheretherketone (PEEK) and polyether ketone ketone (PEKK); polyetherimide; polysulfone; poly(phenylene sulfide); cellulose acetate; poly(vinyl acetate); or a mixture of two or more of these polymers.

In particular, the thermoplastic polymer matrix may be a poly(methyl methacrylate) (PMMA) resin.

In the composite material, the thermoplastic polymer matrix is intimately bound to the reinforcement. The reinforcement may be seen as a reinforcing means, often based on glass or carbon fibers. For example, the reinforcement may be a woven fabric, webs, felts or a fibrous material based for example on glass fibers, carbon fibers or basalt fibers. In particular, the composite material of the article to be recycled is based on PMMA and fibrous materials.

During the recycling of an article comprising a composite material, the polymer matrix is destructured or depolymerized.

The recycling of the article comprising a composite material, and more particularly the destructuring of the composite material, may be carried out by methods such as: pyrolysis, high-temperature pyrolysis, heat treatment in a fluidized bed reactor, heat treatment in an extruder or conveyor, heat treatment in a rotary furnace, pyrolysis in a mechanically-stirred bed, pyrolysis in a molten salt bath or depolymerization by solvolysis including a temperature rise.

FIG. 1 shows a diagram of steps of the article recycling process according to a first embodiment. This recycling may be seen as a process in which the polymer matrix of the composite is converted to provide residues in the molten state and/or residues in the gaseous state, and in which a solid residue, comprising the reinforcement, is produced. For this, in a step 110, the article to be recycled is introduced into a reactor suitable for polymer recycling. Next, the article is heated in a step 120 using a suitable heating means. For example, the heating may be carried out by a bed of molten lead, a fluidized bed (for example of sand), exposure of the article to microwaves, to pulsed electric fields or to steam, or by contact with a hot surface as in an extruder, a screw conveyor, etc. The hot surface may be heated by various means: direct electric heating, heating by heat-transfer fluid (steam, oil, molten salts, etc.). The article is heated at a given temperature allowing the destructuring of the composite and leading to at least one residue in the molten state and/or one residue in the gaseous state. The heating may for example be carried out at a temperature between 200° C. and 1500° C., preferably between 200° C. and 600° C., more preferably between 200° C. and 500° C. and more preferably still between 300° C. and 500° C.

The depolymerization of the composite also leads to the formation of a solid residue comprising the reinforcement. In a step 130, the reinforcement is separated from the destructured polymer matrix. This reinforcement is then brought into contact, in a step 140, with a first heat-transfer means so that the heat stored by the reinforcement is transmitted to a fluid, it being possible for the fluid to be liquid or gaseous.

Moreover, when the depolymerization is not carried out to 100% conversion, the portions of non-depolymerized or non-gasified polymers may have stored heat and return it to the first heat-transfer means. Thus, when the depolymerization is not carried out to 100% conversion, the process comprises a concomitant step, during which the non-depolymerized fraction is brought into contact with the first heat-transfer means. In that case, the sensible heat and/or the heat of fusion of the polymer stored by the non-depolymerized fraction can be transmitted to a fluid which may be liquid or gaseous according to the same sequence as the reinforcement. Furthermore, the process may comprise an additional step during which the non-depolymerized fraction may be completely or partially oxidized thus producing a heat of combustion which is recovered by a heat-transfer means. This additional step may or may not be concomitant with the recovery of the sensible heat from the reinforcement. The heat recovery from the non-depolymerized fraction thus makes it possible to further improve the overall energy balance.

Advantageously, it is also possible according to the process, to recover the heat of combustion stored by the impurities of the depolymerization after a step of purifying the MMA resulting from the depolymerization. Thus, it is possible to transfer the heat accumulated in the reinforcement, in the non-depolymerized fraction or in the impurities with a view to reusing this heat.

The heat thus recovered is advantageously recovered at one or more thermal levels so as to be able to make the best use of it in downstream operations for purifying the monomer obtained or upstream operations for drying or preheating materials. Thus, the process makes it possible to carry out a recycling of articles comprising a composite material for which the carbon footprint and the energy consumption of non-renewable resources are reduced. The process according to the invention is therefore more environmentally friendly.

It should be noted that the article to be recycled may be a manufactured product or part of a manufactured product at the end of its life, or waste from the production of such a product. In both cases, a prior sorting step may prove necessary in order to eliminate non-depolymerizable waste or any non-depolymerizable product also contributing to losses in energy efficiency.

In one embodiment, the process for recycling the article comprises a prior sorting step, before the implementation of the process described above with reference to the diagram of steps from FIG. 1. The sorting step may be a step in which the article comprising a composite material is separated and isolated. For example, it may be separated and isolated from articles not comprising composite material, and/or it may be separated and isolated from contaminants such as glass, sand or metals. The sorting step also allows the separation and sorting of plastics by family. For example, it is possible to sort the thermoplastic polymers on the one hand and the thermosetting polymers on the other hand. The sorting may also make it possible to eliminate portions resulting from the grinding which are not made of composite material.

The sorting may be carried out by any sorting method suitable for polymer recycling. One possible sorting method may involve a decantation system in which the waste is placed in a tank of water and/or brine. The heavy components are found at the bottom of the tank, and can be discharged via a pneumatic airlock system. The components to be recycled can be removed from the tank using an endless screw. The sorting may also comprise magnetic sorting in order to extract metal particles. The sorting may also comprise eddy-current separation to remove certain metals such as copper. It is also possible to combine separation technologies, such as sorting by density in a solution, and magnetic separation, for example. The sorting can be carried out in a sorting center. The sorting step advantageously makes it possible to discharge components which could damage the various devices used in the implementation of the recycling process.

In order to introduce the article to be recycled into the reactor suitable for polymer recycling, introduction means can be used. For example, the article may be introduced into the reactor by means of an endless screw, a conveyor belt, a hopper or by a metering module. The flow rate for feeding the reactor with articles to be recycled may be between 10 kg/h and 2000 kg/h, and preferably between 50 kg/h and 500 kg/h, preferably between 100 kg/h and 400 kg/h.

In order to facilitate the introduction of the article into the reactor suitable for polymer recycling, the article may be ground beforehand. Thus, in one embodiment, the process for recycling the article comprises a step of grinding the article, carried out before step 110 of FIG. 1. The grinding step makes it possible to reduce the dimensions of the article to be recycled and may for example be carried out using any suitable mechanical grinder. The article is reduced to dimensions permitting the introduction of the ground material obtained into a device suitable for the recycling according to the invention. The particles obtained after grinding may for example have a size such that at least one dimension is between 1 and 100 mm, preferably between 3 and 50 mm. Preferably, at least one of the dimensions is less than 3 mm. The article may then take the form of chips, granules or powder. The article may also be introduced into the reactor in one or more of the abovementioned forms. Advantageously, the grinding step may make it possible to facilitate a sorting step. This is why it may be carried out before the sorting operations described above.

Advantageously, the process for recycling the article comprises a step of preheating the article to be recycled. This step of preheating the article may be carried out before the introduction thereof into the reactor and, where appropriate, after grinding. The preheating may be carried out using any suitable heating means. In one variant, it may be initiated in the reactor suitable for polymer depolymerization. The temperature at which the article is preheated may be 50° C. or more, for example 200° C. By preheating the article, a portion of the polymer may be converted to the melt state or the liquid state and/or the depolymerization of the polymer matrix may be facilitated. Advantageously, the preheating of the article can be carried out by virtue of the heat recovered by a heat-transfer means, from heat recovered on site. In this case, energy savings are achieved and the process has a favorable energy balance and is therefore more environmentally friendly. Furthermore, the rate of depolymerization is increased when the article is preheated, and thus the recycling process is generally faster.

In order to recycle the composite material article and in order to destructure the polymer part of the composite, the article is placed in a reactor. For example, the reactor may be an extruder or conveyor, a reactor suitable for pyrolysis, for high-temperature pyrolysis, for pyrolysis in a molten salt bath, or a fluidized bed reactor or a reactor suitable for solvolysis or else a reactor consisting of hollow plates heated by a heat-transfer fluid circulating in the plates.

An extruder-conveyor is a reactor comprising one or more endless screws each actuated in a barrel, in particular allowing the mixing of the components introduced into said barrel. The use of an extruder-conveyor for performing the recycling process is advantageous from an environmental, security and safety viewpoint of the process. Specifically, an extruder-conveyor makes it possible to process molten polymers of high viscosity without the need to add solvent to reduce the viscosity of the molten polymers. The extruder-conveyor has the advantage of allowing efficient heat transfer from the barrel to the composite to be treated. The extruder can advantageously be replaced by a screw conveyor system over all or part of the length thereof. Advantageously, the system may comprise the combination of a conveyor-type device in the first part, followed by an extruder-type device and terminated by a conveyor-type device configured to transport the solid (i.e. reinforcement) to the outlet.

A reactor for receiving the article to be recycled comprising a composite material may be a circulating fluidized bed reactor. A circulating fluidized bed reactor is a reactor in which the fluidization velocity is of the order of 4 to 8 m/s in the transport section of the fluidized bed, i.e. higher than the fluidization velocity of a conventional fluidized bed which is from 0.4 to 1 m/s. In this type of reactor, a fast fluidized bed is in the bottom part, surmounted by a section of smaller diameter. In the lower part there is a strong mixing of the composite and the heat-transfer solid to enable efficient heat transfer. The depolymerization/gasification produces an additional gas volume which then entrains the composite and the heat-transfer solid upward. At the top of the reactor, a release zone makes it possible to return the heat-transfer solid to a vessel in order to reheat it, and to extract the gases produced and also the fibers and other solids. This device has the advantage of enabling better heat exchange between the entrained solid particles.

A reactor suitable for recycling the article may also be a pyrolysis reactor, for example a multistage pyrolysis reactor or a stirred rotating cylinder reactor. Two configurations are possible: either the cylinder rotates on its axis, or an internal stirring system ensures mixing.

Another example of a reactor suitable for recycling the article may be a high-temperature pyrolysis reactor. Such a reactor comprises a vitreous magma and the treatment temperature of the article is between 1200° C. and 1500° C. On leaving the reactor, glass granules are recovered, in particular if the composite material is based on glass fibers.

A reactor which can be used for recycling the article comprising a composite material may be a reactor for pyrolysis in a molten salt bath in which the depolymerization generally takes place between 400° C. and 500° C. The article is immersed in the molten salt bath to enable the depolymerization of the matrix. The fiber can be recovered by filtration from the bath, for example. The salt bath may be composed of a eutectic mixture such as eutectic CaCl₂) or eutectic NaCl—Na₂CO₃. Advantageously, pyrolysis in a molten salt bath is suitable for the treatment of thermosetting polymers or of composite materials contaminated with paints or varnishes, for example.

Another type of reactor that can be used consists of hollow plates, heated by a heat-transfer fluid circuit (pressurized steam, oil, molten salts, etc.). In the course of its treatment, the article advances over the plates of increasing temperatures in a first stage. The solid residue ends its passage through the reactor by passing over plates which are at a lower temperature and where the heat exchange now takes place from the residue to the heat-transfer fluid. The heat-transfer fluid thus reheated can then be used to preheat the article at the reactor inlet.

In all the examples of reactors discussed above, the article made of composite material is heated in the reactor at a given temperature enabling the destructuring or depolymerization of the constituent polymer of the composite. Such a temperature may be between 200° C. and 1500° C., depending on the type of reactor and the destructuring technique used. In the case of a composite comprising PMMA, the given destructuring temperature may be between 300° C. and 600° C., preferably from 350° C. to 500° C., more preferably between 400° C. and 450° C., this temperature range being particularly suitable for the destructuring of PMMA which is a polymer of interest.

In a preferred embodiment, the heating of the article is carried out under an inert atmosphere, for example under vacuum, under nitrogen, under CO₂ or under argon or under an atmosphere that is substantially low in oxygen (for example having from 0.1% to 10% oxygen). Alternatively, when the production of a synthesis gas via gasification is desired, then the heating of the article is carried out in the presence of a reactive gas containing oxygen. In order to control the atmosphere in which the heating of the article is carried out, the reactor can be isolated from the feed part, either by a feed lock, or by a plug of molten polymer for example, or by any other means. Thus, the reactor into which the article is introduced can be hermetically isolated during the operation thereof and more particularly during the heating/pyrolysis/depolymerization step. By way of example, the oxygen composition in the reactor can be controlled and adapted to the nature of the composite. Such an oxygen-depleted atmosphere can, for example, be obtained by recycling the combustion gases of the light effluents from the depolymerization unit. After combustion, the oxygen content can be brought to the appropriate range.

It is recalled that with the recycling process according to the embodiments, the polymer matrix is destructured and is converted, for example, into a mixture in the molten or liquid state, or into a mixture in the gaseous state. Thus, the process comprises a separation step in which the reinforcement and the destructured matrix are separated from each other and isolated. The separation means is adapted to the state of the matrix in the reactor or at the outlet of the reactor, i.e. depending on whether the matrix is converted into a mixture in the molten or liquid state, or is converted into a mixture in the gaseous state. In the case where the reinforcement is contained in a mixture in the molten or liquid state, the separation means can be any means allowing a solid/liquid separation, such as a grid for example. The separation can also be carried out by centrifugation using a centrifuge, or else by decantation, filtration, draining, spinning, pressing or screening. Preferably, the separation is carried out by filtration in a molten medium, pressing or decantation. In the case where the matrix is gasified/depolymerized, the separation means may comprise a cyclone or filters, for example. When filters are used, back pressure is applied periodically to loosen the solid that has accumulated at the filter. The solid cake is then recovered below the filter in a vessel provided for this purpose. It should be noted that during depolymerization of the matrix, polymer residues may remain on the reinforcement.

Optionally, a portion of the destructured matrix is reintroduced into the reactor. Specifically, during the separation step, the mixture in the molten or liquid state may be recovered in a chamber provided for this purpose. In the case of a mixture in the gaseous state, the gas can be extracted from the reactor through ducts in order to be condensed in a condenser provided for this purpose. The chamber containing the mixture in the molten or liquid state may be connected to the reactor, via a return duct or leg for example, in order to enable the reintroduction of said mixture into the reactor. The mixture in the molten state contains in particular polymers of reduced weight. Thus, advantageously, the reintroduction of the mixture in the molten state, resulting from the destructuring of the matrix, makes it possible to facilitate the destructuring of the matrix of a next article, or the next batch of articles, and/or to improve the degree of conversion of the matrix. Furthermore, the condensation of the gas mixture can be carried out in a fractional manner and lead to clean fractions containing the base monomer, and less-clean fractions containing monomer and contaminants. This fraction containing contaminants can also be reintroduced into the reactor in order to enable a better separation of the monomers contained in this fraction.

In the recycling process, the reinforcement obtained after the step of separating and isolating the reinforcement is brought into contact with a first heat-transfer means and optionally a second heat-transfer means.

The heat-transfer means is advantageously a heat exchanger. Conventionally, a heat exchanger enables heat transfer between two fluids. In the recycling process, the heat transfer takes place between a solid and a heat-transfer fluid. The solid and the fluid may be stationary, or they may both be in motion, or else the solid is stationary while the fluid is in motion. The solid and the fluid may circulate parallel to each other and in the same direction. However, the solid and the fluid may circulate parallel to each other but in opposite directions. They may also circulate perpendicularly.

The heat transfer may be performed by a direct-contact heat exchanger. Thus, during heat transfer performed by a direct-contact heat exchanger, the hot reinforcement is in intimate contact with the heat-transfer fluid. The fluid may be a liquid, for example water, a solvent or a mixture thereof. In other examples, the fluid may be a gaseous fluid such as a stream of air or of gas, for example. The contact with the fluid may be performed using an immersion or spraying device. Preferably, the contact is made by spraying so as to produce high-temperature vapor. This spraying may be followed by an immersion. The contact may also be performed by means of a nozzle or a series of nozzles having holes through which the fluid can escape, the nozzles being oriented toward the solid component. Other heat-transfer fluids may be used; preferably, the fluids available on site are used. For example, water, air, gas, and also the co-products of depolymerization, in particular hydrocarbons being able to be used as fuel oil and/or as secondary heat-transfer fluid. Specifically, the hydrocarbons vaporize, in a similar manner to water, on contact with the hot residue. The hot gas is directed toward a boiler where the hydrocarbons are condensed while bringing the water to the boil. This water will be used in the process or for heating a primary heat-transfer fluid.

As a variant, the heat transfer may be performed by an indirect-contact heat exchanger. Such a heat exchanger may be, for example, a tubular exchanger, a plate exchanger, an exchanger with a horizontal tube bundle, an exchanger with a vertical tube bundle, a spiral exchanger, a fin tube exchanger, or else a rotary or block exchanger. These examples are not limiting, and a person skilled in the art will appreciate that other types of indirect-contact heat exchangers may be used. An indirect-contact heat exchanger may also use a heat-transfer fluid. The heat-transfer fluid may be a liquid, for example water, a solvent or a mixture thereof, molten salts or else synthetic oil. For example, such a synthetic oil may be the product sold by Arkema under the name Jarytherm (registered trademark).

The advantage of an indirect-contact heat exchanger is that it enables heat recovery at different thermal levels. In other words, it is possible to recover heat at several thermal levels, each thermal level being associated with a different temperature. It is possible to have heat exchangers in cascade (or in stages) so as to enable heat exchange with the reinforcement which is increasingly less hot from one exchanger to the next.

In order to carry out the recycling process, it is possible to use a system comprising in particular:
a means for conveying said composite article,
a reactor suitable for heating said article with a view to destructuring the polymer matrix thereof,
a means for separating the reinforcement from the destructured polymer matrix, and
a first heat-transfer means suitable for recovering heat from the reinforcement.

The recycling process in which the reactor is a fluidized bed reactor will now be described. With reference to the diagram in FIG. 2, the article 201 made of composite based on PMMA and fibers is introduced into a fluidized bed reactor 202 by a hopper or endless screw 216, preferably at a low point of the reactor (since the articles 201 may tend to rise in the fluidized bed). The article 201 is in the form of particles of around 25 mm, obtained by grinding (not shown).

An inert fluidizing medium is also introduced into the reactor. This medium can be, for example, sand, ceramic particles, metal particles, metal oxide particles, metal hydroxide particles or metal halide particles.

The inert particle medium and the article 201, in the form of ground particles, form a mixture of solid particles 203 which is suspended in a hot ascending gas stream 204, above a distribution support/grid 205. The inert particle medium is reheated by the hot gas stream and/or in an external vessel (not shown). In the latter case, the solid present in the reactor 202 is withdrawn, for example by endless screws, in order to be reheated in the external vessel before being returned to the reactor 202. The reheating can be carried out by combustion of the carbonaceous residues of the article 201 and/or by external heat input.

The gas stream can be based on nitrogen, carbon dioxide, monomer or steam for example, and it is optionally heated at a temperature between 450° C. and 550° C.

The support 205 may be a grid or a diffuser which does not allow the particles to pass downward but allows the gas stream to pass upward.

The fluidizing gas 204 is injected into the bottom part 206 of the reactor and its flow rate is such that it must enable the fluidization of the mixture of particles. The gas flow leads to movement of the mixture of particles and mixing promoting the heat transfer. In the reactor, the PMMA-based matrix is depolymerized by the action of heat to result notably in the methyl methacrylate monomer in gas form. The gases 207 produced in the reactor are carried to a gas/solid separator 208 such as a cyclone. Such a separator can be internal or external to the reactor. There may also be a multiplicity of internal and external separators in series, the first one having the objective of keeping the inert particles in the reactor, and the following ones having the objective of recovering the particles of the reinforcement 209.

In order to recover the heat stored in the reinforcement 209, the latter is recovered into a chamber 210 provided for recovering the reinforcement after separation. The chamber 210 is isolated from the separator 208 by any suitable means for potentially preventing the gases generated in the reactor from following the same path as the reinforcement. This can be achieved using an endless screw, an airlock, a flow of inert gas providing back pressure or any other means. Since the reinforcement is recovered after the depolymerization process carried out in the reactor, it has a temperature substantially equal to the temperature in the reactor. The chamber 210 may have an orifice 211 provided with means for regulating the entry of heat-transfer fluid into the chamber 210. The chamber may also have an outlet 212 to allow the heated heat-transfer fluid to exit. In the case of a liquid fluid, for example water, the latter is conveyed to the chamber 210 from an external reservoir 213.

The fluid can be conveyed by any suitable means, for example by flexible or rigid ducts, or pipes.

The water is introduced into the chamber 210 through the inlet orifice 211. In the example shown, the hot reinforcement 209 is brought into contact by spraying and/or immersion with the water entering through the orifice 211, preferably by spraying. After the fluid has been brought into contact with the reinforcement, the heat transfer is carried out and results in the production of hot steam 214. The heat thus recovered in the form of hot steam is extracted from the chamber 210 through the outlet 212.

Advantageously, the recovered heat can be used in the recycling process of the invention, in addition to heat input by an external heat source. A heat source is understood to mean all the examples of heating means already described.

For example, this heat can be used on site for preheating 215 of the article 201. The recovered heat can also be used in monomer purification steps. For example, the gases 207 can be condensed using a condenser, and the condensate obtained can be hydrolyzed with hot steam. This hot steam can be obtained by heating an aqueous solution, the heating being carried out with the recycled heat. The hydrolysis can also be carried out by direct contact of the steam obtained by contact of water and of the hot reinforcement with the condensate or the vapors 207, in the presence or absence of a hydrolysis catalyst. The hydrolysis products can then be separated by crystallization, for example, or by any other equivalent technique.

Referring to FIG. 3, the heat exchanger 300 may be a plate-type exchanger with multiple plates (301a and 301b). These plates 301a and 301b are hollow and may be of generally rectangular or circular shape, or else of cylindrical or semi-cylindrical shape (e.g. a trough). In one example, they are placed parallel to one another, more precisely flat and one above the other. The space between the plates is small, of the order of a few millimeters to a few centimeters, however it allows the passage of the reinforcement. Each plate 301 has an interior space in which a heat-transfer fluid circulates. The first fluid 302 entering a first plate 301a may have a temperature T1e different from the temperature T2e of the second fluid 303 entering a second plate 301b. The hot reinforcement 209 may be placed on a first plate, on which it rests by gravity, so that the heat transfer takes place by conduction of heat through the upper wall of the plate. The solid residue (i.e. reinforcement) travels from one plate to the next by gravity or by means of “pushers” which move the solid residue (i.e. reinforcement) forward over the plates. The contact time between the reinforcement and a heat-transfer means may be between 1 minute and 10 hours, between 100 and 450° C.

After a given time, the reinforcement is moved by setting-in-motion means toward the second plate, on which it then rests, still by gravity. The movement can be continuous or discontinuous. There, the heat transfer takes place with the fluid 303 in the second plate. Alternatively, the reinforcement can be set in motion using a pusher, an endless screw or by gravity. The heat exchanger can take several forms. For example, in the case of stacked circular plates, scrapers are present along a central axis making it possible to advance the reinforcement along the plate. In each plate there is an outlet, enabling the reinforcement to fall onto a plate at a lower height and which is at a different temperature. In the case of rectangular plates, which may be slightly inclined, scrapers are present on each plate enabling the reinforcement to advance. Once at the end of the plate, the reinforcement moves on to another plate while the scrapers pass under the plate to make a complete circuit of the plate. In the case of using an extruder/conveyor, the extruder/conveyor may have sections that are heated independently, and therefore, at the end of the extruder/conveyor, conversely, the sections may be cooled independently.

Other plates can thus be used successively for the same batch of reinforcements, in order to carry out heat transfer, successively, at respective decreasing thermal levels. Advantageously, the fluid leaving the first plate 301a has a temperature T1s, the fluid leaving the second plate 301b has a temperature T2s, the temperatures T1s and T2s being different. Thus, owing to the plate-type heat exchanger, it is possible to recover fluids at the outlet of the plates that have different temperatures. It may also be the same fluid that passes countercurrently from one plate to the next. Depending on the desired use for the heated fluid which is recovered in the application considered, it is possible to choose the fluid inlet temperature in order to obtain an outlet temperature of a certain order, depending on the temperature of the reinforcements deposited on the plate, on the hold time of the reinforcements on the plate, and on the thermal properties of the latter.

In one embodiment, the heat-transfer means, for example the first heat-transfer means, is suitable for setting the fibrous reinforcement in motion during the heat transfer. In order to minimize the effects of movement of the reinforcement over the heat-transfer means, a protection agent may be added to the reinforcement. Advantageously, the protection agent also makes it possible to promote heat exchange between the reinforcement and the heat-transfer means.

A second embodiment of the recycling process, in the form of a step diagram, will now be presented. Referring to FIG. 4, the article to be recycled, originating from household waste, is sorted in a step 410. Next, in a step 420, the article comprising a composite material is ground to produce particles of around 20 mm. In a step 110, the ground particles are introduced into a pyrolysis reactor using a metering module, with a flow rate of 50 kg/h. The pyrolysis reactor is heated at a temperature of between 300° C. and 550° C., in a step 120. Under the effect of heat, the polymer matrix depolymerizes to give a mixture in the molten state and a solid comprising the reinforcement. The reinforcement is separated from the mixture in the molten state in a step 130, using a separation means. In a step 140, the reinforcement having stored heat is placed in a plate-type heat exchanger so that the stored heat is recovered. The recovered heat can be used in a step 430 of preheating the article after grinding.

According to one variant, the recycling process comprises a step in which the reinforcement is brought into contact with a first heat-transfer means, then the reinforcement is set in motion and moved toward a second heat-transfer means. This can for example make it possible to recover additional heat, after the recovery of a first amount of heat by bringing the reinforcement (e.g. fibrous reinforcement) into contact with the first heat exchanger. Thus, several transfer means can be used in order to optimize heat recovery.

It should be noted that the energy recovered according to the process varies with the fiber content of the material and the degree of conversion of the polymer. An illustration of this feature is shown in table 1.

TABLE 1

| Fiber content | Degree of conversion of | Percentage |
|---|---|---|
| (as % of the total | the polymer (as | of recoverable |
| weight) | percentage) | energy |
| 30 | 10 | 85 |
| 90 | 10 | 95 |
| 50 | 50 | 46 |
| 30 | 90 | 11 |
| 90 | 90 | 59 |

Thus, the recycling process with improved energy balance is particularly well suited for energy recovery if the composite material comprises more than 70% fibers and/or if the process does not allow more than 70% conversion of the polymer. Specifically, in particular when, under these conditions, the composite material comprises more than 70% fibers and the process allows less than 70% conversion of the polymer, then more than 40% of the energy needed is recoverable.

The process is particularly advantageous for the recycling of composite material with heat recovery for a fiber percentage of greater than 40%, more than 10% of the energy needed is recoverable, irrespective of the degree of conversion.

Finally, the overall energy balance can be improved, for example in the case of a low fiber content and a high degree of conversion, by recovering the energy of complete or partial combustion of the polymer which has not been converted and the combustion energy of the impurities separated from the depolymerized monomer. A partial conversion/combustion/oxidation of the polymer is understood to mean both a conversion which is not complete, involving a polymer residue, and an oxidation which gives products other than CO₂, and for example CO, acids and light aldehydes, and hydrocarbons.

Thus, the present invention proposes a simple and effective solution for depolymerizing a constituent polymer of a composite material article, making it possible to improve the energy balance and in particular to recover the amount of heat absorbed by the solid, non-depolymerizable, fibrous material. The process makes it possible to carry out a recycling of articles comprising a composite material, the carbon footprint of which is reduced and which is therefore more environmentally friendly.

1. A process for recycling an article comprising a composite material, said composite material comprising a polymer matrix and a reinforcement, said process comprising the following steps:
introducing (110) the article into a reactor suitable for heating the article,
heating (120) the article in the reactor at a given temperature, in order to destructure the polymer matrix,
separating (130) the reinforcement from the destructured polymer matrix, and
contacting (140) the reinforcement with a first heat-transfer means in order to recover heat.

2. The recycling process as claimed in claim 1, wherein the article is introduced into the reactor by means of an endless screw, a conveyor belt, a hopper or a metering module.

3. The recycling process as claimed in claim 1, wherein the article is heated at a temperature between 200° C. and 1500° C.

4. The recycling process as claimed in claim 1, wherein the reinforcement is separated by at least one of the following processes: centrifugation, draining, spinning, pressing, filtering, screening and/or cycloning.

5. The recycling process as claimed in claim 1, wherein the first heat-transfer means is a heat exchanger with direct contact between the reinforcement and a heat-transfer fluid.

6. The recycling process as claimed in claim 5, wherein the first heat-transfer means is a device for immersion in the heat-transfer fluid or for spraying the heat-transfer fluid.

7. The recycling process as claimed in claim 1, wherein the first heat-transfer means is a heat exchanger with indirect contact between the reinforcement and a heat-transfer fluid.

8. The recycling process as claimed in claim 1, wherein characterized in that a protection agent is added to the reinforcement.

9. The recycling process as claimed in claim 1, wherein the recovered heat is used in the article recycling process in addition to heat input by an external heat source.

10. The recycling process as claimed in claim 1, wherein the recovered heat is used to preheat the article before the introduction thereof into the reactor.

11. The recycling process as claimed in claim 1, wherein said process further comprises a step consisting of bringing the reinforcement into contact with a second heat-transfer means in order to recover additional heat, after the heat recovery by contacting the reinforcement with the first heat-transfer means.

12. The recycling process as claimed in claim 1, wherein the destructuring of the composite material comprising a polymer matrix and a reinforcement is carried out by methods chosen from pyrolysis, high-temperature pyrolysis, heat treatment in a fluidized bed reactor, heat treatment in an extruder or conveyor, heat treatment in a rotary furnace, pyrolysis in a mechanically-stirred bed, pyrolysis in a molten salt bath or depolymerization by solvolysis including a temperature rise.

13. The recycling process as claimed in claim 1, wherein the polymer matrix is a matrix made of thermosetting polymer or of thermoplastic polymer.

14. The recycling process as claimed in claim 1, wherein the polymer matrix is chosen from the group consisting of a homopolymer and copolymer of olefins, acrylonitrile-butadiene-styrene copolymers, styrene-butadiene-alkyl methacrylate (SBM) copolymers; polyethylene, polypropylene, polybutadiene and polybutylene; acrylic homopolymers and copolymers, polyalkyl methacrylates, poly(methyl methacrylate); homopolyamides and copolyamides; polycarbonates; polyesters poly(ethylene terephthalate), poly(butylene terephthalate); polyethers, poly(phenylene ether), poly(oxymethylene), poly(oxyethylene), poly(ethylene glycol), poly(oxypropylene); polystyrene; copolymers of styrene and maleic anhydride; poly(vinyl chloride); fluoropolymers, poly(vinylidene fluoride), polyethylene tetrafluoride, polychlorotrifluoroethylene; natural and synthetic rubbers; thermoplastic polyurethanes; polyaryl ether ketones (PAEK), polyetheretherketone (PEEK), polyether ketone ketone (PEKK); polyetherimide; polysulfone; poly(phenylene sulfide); cellulose acetate; poly(vinyl acetate); and a mixture of two or more of these polymers.

15. The recycling process as claimed in claim 1, wherein the polymer matrix comprises polymethyl methacrylate (PMMA).

16. The recycling process as claimed in claim 1, wherein a portion of the destructured matrix is reintroduced into the reactor after separation from the reinforcement.

17. The recycling process as claimed in claim 1, wherein the composite contains more than 40% by weight of reinforcement.

18. The recycling process as claimed in claim 17, wherein the composite contains more than 70% by weight of reinforcement.

19. The recycling process as claimed in claim 1, wherein the recovered heat is recovered at one or more thermal levels.

20. The recycling process as claimed in claim 1, wherein the process for recycling the article comprises a prior sorting step, before the implementation of the process.

21. The recycling process as claimed in claim 1, wherein the article is introduced into the reactor with a flow rate for feeding the reactor with articles to be recycled of between 10 kg/h and 2000 kg/h.

22. The recycling process as claimed in claim 1, wherein the article recycling process further comprises a step of grinding the article.

23. The recycling process as claimed in claim 1, wherein the recycling process further comprises a step of preheating the article to be recycled.

24. A system for recycling an article comprising a composite material comprising a polymer matrix and a reinforcement, said system comprising:
a means for conveying said article,
a reactor suitable for heating said article with a view to destructuring the polymer matrix thereof,
a means for separating the reinforcement from the destructured polymer matrix, and
a first heat-transfer means suitable for recovering heat from the reinforcement.

25. The recycling system as claimed in claim 24, wherein said process further comprises a second heat-transfer means capable of recovering additional heat from the reinforcement.

26. The recycling system as claimed in claim 24, wherein the separation means is in one of the following forms: a centrifuge, a drainage means, a spinning means, a pressing means, a filter, a screen and/or a cyclone.
